(19) United States
(12) Patent Application Publication
(10) Pub. No.: US 2008/0005126 A1
(43) Pub. Date: Jan. 3, 2008

(54) SYSTEM AND METHOD FOR MANAGING AND ACCESSING ONE OR MORE MULTIMEDIA CONTENTS

(76) Inventors: Ayyappan Sankaran, San Jose, CA (US); Jayant Kadambi, Mountain view, CA (US)

Correspondence Address: Global IP Services PLLC, 198 F, 27th Cross,3rd Block Jayanagar,, Bangalore, 560011, omitted

(21) Appl. No.: 11/620,733

(22) Filed: Jan. 8, 2007

Related U.S. Application Data
(60) Provisional application No. 60/806,110, filed on Jun. 29, 2006.

(51) Int. Cl. G06F 17/30

(52) U.S. Cl. 707/10

(57) ABSTRACT

A system and a method for managing one or more multimedia contents is provided. The method includes bookmarking one or more multimedia contents. The method further includes storing one or more bookmarks in a server in response to bookmarking one or more multimedia contents. A bookmark corresponds to a multimedia content. Thereafter, one or more multimedia contents are accessed using one or more bookmarks stored in the server. Accessing one or more multimedia contents using one or more bookmarks facilitates in monetizing one or more advertisements associated with one or more multimedia contents.

This application claims priority under 35 USC [symbol] 119 (e) (1) of provisional application No. 60/806,110 Filed on 29 Jun. 2006.

### FIELD OF INVENTION

The present invention generally relates to managing and sharing content over a communication network. More specifically, the present invention relates to a system and method for managing and accessing one or more multimedia contents.

### BACKGROUND OF THE INVENTION

In order to access a multimedia content available through the internet, a user searches for a website hosting the multimedia content. Thereafter, the user accesses the website and browses the website to view or download the multimedia content. The multimedia content may be played on a software application embedded into an internet browser running on a computing platform of a device the user. Alternatively, the user may download an application that runs on the computing platform of the device used by the user. The application plays the multimedia content. Additionally, one or more advertisements may be associated with the multimedia content so as to generate advertisement monetization for a content owner of the multimedia content.

In conventional systems, a user may require registering with a website in order to access a multimedia content hosted by the website. Therefore, in order to access one or more multimedia contents hosted by one or more websites and in order to share them with the user's social network, the user and each user in the user's social network has to register separately with each website. As a result, the process of managing and sharing multimedia content becomes exponentially cumbersome, as disparate websites used by the user's social network increases.

Therefore, there is a need of a method and system in which a user can access one or more multimedia contents and share them with the user's social network through a single cohesive environment.

### SUMMARY OF THE INVENTION

An object of the invention is to provide a method and system for managing and accessing one or more multimedia contents.

Another object of the invention is to provide a method and system for providing accurate advertisement monetization to a content owner of a multimedia content.

The above listed objectives are achieved by providing a system and method for managing one or more multimedia contents is provided. The method includes bookmarking one or more multimedia contents. The method further includes storing one or more bookmarks in a server in response to bookmarking one or more multimedia contents. A bookmark corresponds to a multimedia content. Thereafter, one or more multimedia contents are accessed using one or more bookmarks stored in the server.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram showing an environment (that is exemplary) in which various embodiment of the invention can function.

FIG. 2 is a flowchart of a method for managing one or more multimedia contents, in accordance with an embodiment of the invention.

FIG. 3 is a flowchart of a method for managing one or more multimedia contents, in accordance with another embodiment of the invention.

FIG. 4 is a flowchart of a method for associating one or more advertisements with a multimedia content, in accordance with an embodiment of the invention.

FIG. 5 is a flowchart of a method for accessing one or more multimedia contents from a server, in accordance with an embodiment of the invention.

FIG. 6 is a block diagram showing a system for managing one or more multimedia contents, in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to a system and method for managing and accessing one or more multimedia contents. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide systems and methods for managing and accessing one or more multimedia contents. Multimedia content may be one or more of a photo, a video, and an audio. The multimedia content may be made available on a website and/or a television channel by a multimedia content owner. The multimedia content owner may be a website owner or a television channel. Additionally, one or more advertisements are associated with a multimedia content. Therefore, when the multimedia content is viewed, one or more advertisements associated with it are also accessed. In response to this, a content owner of the multimedia content is notified to enable advertisement monetization.

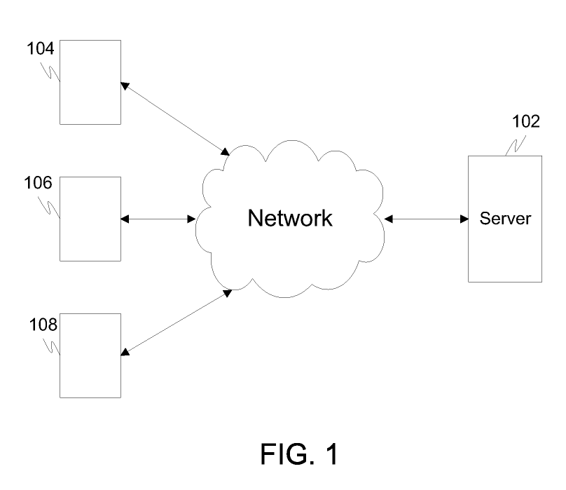

FIG. 1 is a block diagram showing an environment 100 (that is exemplary) in which various embodiments of the invention can function. Environment 100 includes a server 102, a device 104, a device 106, and a device 108. It will be apparent to people skilled in the art that environment 100 may include more than three devices. Examples of a device may include, but are not limited to, a Set Top Box (STB), a television, a cell phone, a Personal Digital Assistant (PDA), a computer, a laptop, a palmtop, and an e-book.

One or more of device 104, device 106, and device 108 access one or more multimedia contents over a communication network through server 102. The communication network may be an Internet Protocol (IP) based network. Server 102 may store information corresponding to one or more multimedia contents accessed by each of device 104, device 106, and device 108. Server 102 may be provided by a cable operator who provides cable service. Alternatively, server 102 may be associated with a website through which a multimedia content is accessed by one or more of device 104, device 106, and device 108.

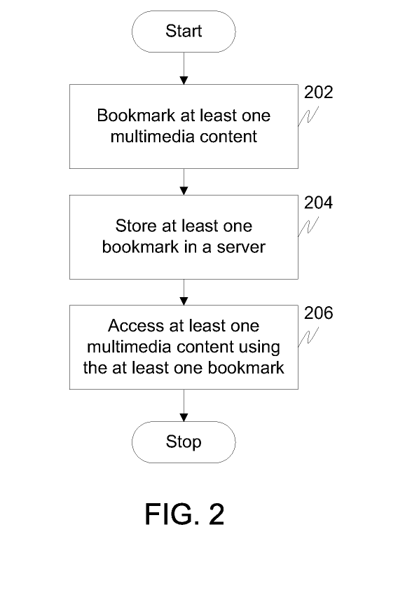

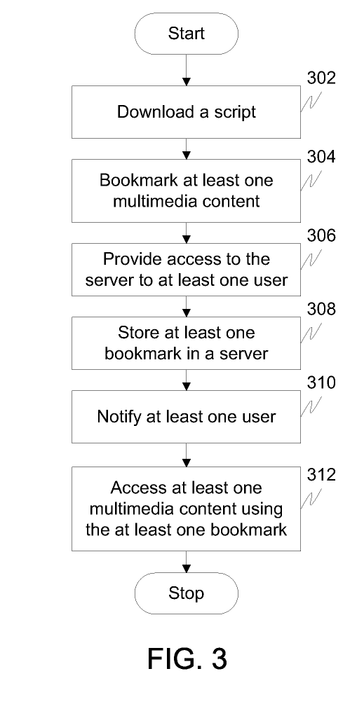

FIG. 2 is a flowchart of a method for managing one or more multimedia contents, in accordance with an embodiment of the invention. A user downloads a script from server 102 on a device used by the user. The user may download the script from a website associated with server 102 while browsing the website. Example of the script may include, but is not limited to, a Java™ code. This is further explained in detail in conjunction with FIG. 3. The user may access one or more multimedia contents while browsing one or more websites. To access one or more multimedia contents in future, the user bookmarks one or more multimedia contents, at step 202. The user may want to share a multimedia content bookmarked by the user with the user's social network. Therefore, the user may provide an access to server 102 to one or more users in the user's social network. This is further explained in conjunction with FIG. 3.

At step 204, one or more bookmarks are stored in server 102 in response to bookmarking one or more multimedia contents. This is enabled by the script downloaded from server 102. A bookmark corresponds to a multimedia content. A bookmark is stored in server 102 as a link and may be made available on a website associated with server 102. The link, for example, may be a Universal Resource Locator (URL). One or more bookmarks are stored by aggregating them in server 102. In an embodiment of the invention, one or more bookmarks may be aggregated such that they are arranged in a list stored in server 102. For example, a list may be created in server 102 in the name of the user.

A bookmark may be placed in the list in accordance with an access pattern corresponding to the bookmark. The access pattern corresponds to a pattern of accessing the bookmark. For example, a bookmark that is accessed the maximum number of times may be placed at top in the list. Similarly, in another example, each bookmark may be assigned a priority number by the user. Further, a bookmark with the highest priority number may be placed at top in the list. Alternatively, the user may manually arrange one or more bookmarks in the list. The user may form a plurality of lists to aggregate bookmarks in server 102. A list in the plurality of lists may correspond to a particular context and a bookmark that is associated with a multimedia content belonging to a particular context, may be associated to the list.

In response to storing one or more bookmarks, one or more users in the user's social network are notified. This is further explained in conjunction with FIG. 3. In an embodiment of the invention, one or more users may not be notified in response to storing one or more bookmarks in server 102. Thereafter, at step 206, a user who has been provided an access to server 102, may access one or more multimedia contents using one or more bookmarks stored in server 102. A user may browse a website associated with server 102 and access one or more bookmarks stored in server 102. A user may click on a bookmark displayed as a link on the website to access a multimedia content corresponding to the bookmark. Accessing a multimedia content using a corresponding bookmark may display the multimedia content on a device used by a user. The multimedia content may be played on a software application embedded in the website browsed by the user. Alternatively, the multimedia content may be played on an application running on a computing platform of a device used by the user. Examples of the device may include, but are not limited to, a STB, a television, a cell phone, a PDA, a computer, a laptop, a palmtop, and an e-book. Alternatively, accessing a multimedia content using a corresponding bookmark downloads the multimedia content on a device used by a user. The multimedia content may be stored on the device for future viewing.

FIG. 3 is a flowchart of a method for managing one or more multimedia contents, in accordance with another embodiment of the invention. At step 302, a user downloads a script from server 102 or a website associated with server 102. The script may be downloaded onto a device used by a user. The script may be written in a programming language. Examples of the programming language may include, but are not limited to, java, C, and C++. At step 304, the user bookmarks one or more multimedia contents to view it in a later stage in time. The user may want to share the one or more multimedia contents bookmarked by the user to the user's social network. Therefore, at step 306, the user provides access to server 102 to one or more users of the user's social network. The user may provide each user a user ID and a password to access server 102. Alternatively, the user may provide one or more users a link of a website associated with server 102.

In response to bookmarking one or more multimedia contents, at step 308, one or more bookmarks are stored in server 102. A bookmark corresponds to a multimedia content. This has been explained in conjunction with FIG. 2. Thereafter, at step 310, one or more users are notified in response to storing one or more bookmarks. The user may notify a user by manually sending a message to the user. Examples of the message may include an e-mail and a Short Messaging Service (SMS). In an embodiment of the invention, a message may be sent automatically to a user from server 102, in response to storing one or more bookmarks. At step 312, one or more multimedia contents are accessed using one or more bookmarks stored in server 102. A multimedia content is accessed by a user who has been provided an access to server 102. This has been explained in conjunction with FIG. 2.

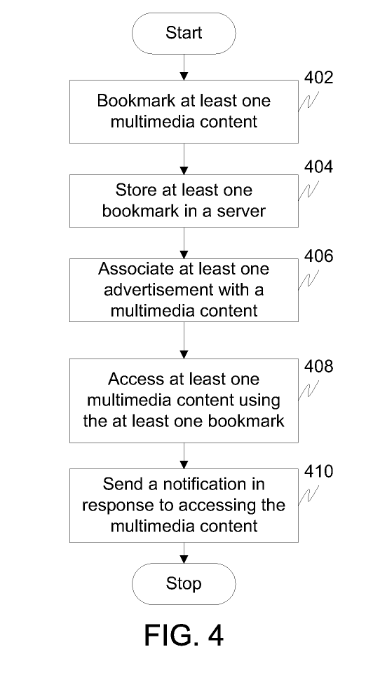

FIG. 4 is a flowchart of a method for associating one or more advertisements with a multimedia content, in accordance with an embodiment of the invention. At step 402, one or more multimedia contents are bookmarked. This has been explained in conjunction with FIG. 2. Thereafter, at step 404, one or more bookmarks are stored in server 102. A bookmark corresponds to a multimedia content. This has been explained in conjunction with FIG. 2.

At step 406, one or more advertisements are associated with a multimedia content accessed using a corresponding bookmark stored in server 102. Thereafter, one or more multimedia contents are accessed using corresponding bookmarks stored in server 102, at step 408. This enables monetizing one or more advertisements associated with a multimedia content. A multimedia content is accessed by a user who has been provided an access to server 102. This has been explained in conjunction with FIG. 2. One or more advertisements may be associated in real-time with a multimedia content, when the multimedia content is being accessed. For example, one or more advertisements may be associated with a multimedia content or the associated advertisements may be updated when a user is viewing the multimedia content on a website associated with server 102. Advertisements may also be associated or updated when the user views the multimedia content on a device in future based on predefined parameters. The predefined parameters may include, but are not limited to, demography of the user and pshycography of the user.

One or more advertisements associated with the multimedia content are viewed when the multimedia content is accessed. An advertisement associated with a multimedia content may be viewed before and/or after the multimedia content is viewed. Alternatively, an advertisement associated with a multimedia content may be viewed simultaneously with the multimedia content. In response to accessing the multimedia content using the corresponding bookmark, a notification is sent to a content owner of the multimedia content from server 102, at step 410.

The notification includes information corresponding to a method used to view one or more advertisements associated with a multimedia content. The notification may be an email or an SMS generated from server 102 for a content owner of the multimedia content. Examples of methods used for accessing one or more advertisements may include, but are not limited to, viewing an advertisement along with a corresponding multimedia content on a website, viewing an advertisement along with the multimedia content on a device used by a user, and viewing a multimedia content and then clicking on an associated advertisement on a website or a device. Additionally, an advertisement can also be viewed in a banner or other advertisement slots available adjacent to the multimedia content being viewed on a website used to view the multimedia content. Further, if the multimedia content has been downloaded, then advertisements can be associated and viewed in one or more of pre-roll, post-roll, mid-roll of the multimedia content, and adjacent to the to the multimedia content. The advertisements can also be overlayed on a multimedia content being viewed. The notification may further includes name of the website used to access a multimedia content, location of user accessing the multimedia content and number of times the multimedia content has been accessed.

As a notification is sent to a content owner of a multimedia content, each time the multimedia content is accessed and as the notification includes the location of a user and the number of times a multimedia content is viewed; therefore, a content owner of the multimedia content receives an accurate advertisement monetization.

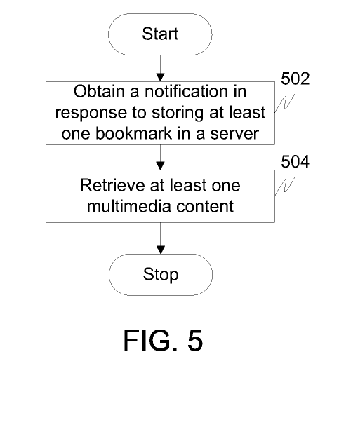

FIG. 5 is a flowchart of a method for accessing one or more multimedia contents from server 102, in accordance with an embodiment of the invention. At step 502, a notification is obtained in response to storing one or more bookmarks in server 102. The notification is obtained by one or more users. The notification may be an SMS or an email. This has been explained in detail in conjunction with FIG. 3.

One or more users are provided an access to server 102. Thereafter, at step 504, one or more multimedia contents are retrieved using one or more bookmarks stored in server 102 by a user. A bookmark is displayed on a website associated with server 102 as links. This has been explained in conjunction with FIG. 2 and FIG. 3. The step of retrieving includes associating one or more advertisement with each multimedia content. This has been explained in conjunction with FIG. 4.

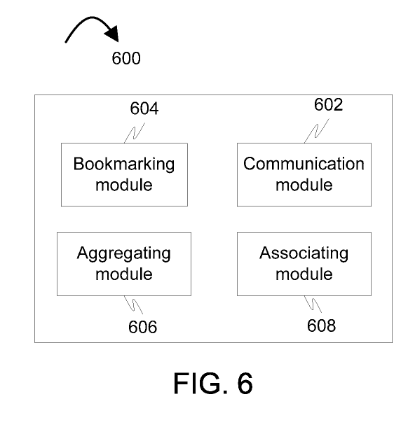

FIG. 6 is a block diagram showing a system 600 for managing one or more multimedia contents, in accordance with an embodiment of the invention. System 600 includes a communicating module 602 and a bookmarking module 604. While browsing one or more multimedia contents, a user bookmarks one or more multimedia contents to view them later in time or to share them with one or more users. Communicating module 602 provides one or more users an access to server 102. This has been explained in conjunction with FIG. 3.

In response to bookmarking one or more multimedia contents, bookmarking module 604 stores one or more bookmarks in server 102. A bookmark corresponds to a multimedia content. This has been explained in conjunction with FIG. 2. Thereafter, an aggregating module 606 aggregates one or more bookmarks in server 102. Aggregating module 606 may aggregate one or more bookmarks to arrange them in a list stored in server 102. This has been explained in conjunction with FIG. 3.

Communicating module 602 communicates a notification to one or more users in response to storing one or more bookmarks in server 102. After receiving the notification, one or more users who have been provided an access to server 102, may access a multimedia content using a corresponding bookmark. This has been explained in conjunction with FIG. 2. For example, a user may create a community or a forum on the Internet. The community may be joined by a plurality of users for which each user may be provided with a password to access the community or forum through emails. Whenever, the user, who created the community, bookmarks a multimedia content, the bookmark for the multimedia content is saved on the community or forum. In response to this, each member of the community is sent a notification that a new bookmark has been saved on the forum or the community. Thereafter, the plurality of users can access the same through the community or the forum.

System 600 may include an associating module 608 that associates one or more advertisements with a multimedia content. An advertisement may be associated with a multimedia content after storing one or more bookmarks in server 102. An advertisement may be associated with a multimedia content in real-time when a user is viewing the multimedia content. This has been explained in conjunction with FIG. 4. If a multimedia content is viewed using a corresponding bookmark, then communicating module 602 sends a notification to a content owner of the multimedia content. This enables accurate advertisement monetization. This has been explained in detail in conjunction with FIG. 4.

Various embodiments of the invention provide methods and systems for managing and accessing one or more multimedia contents. A user bookmarks one or multimedia content that the user wants to view later in time or share it with the user's social network. In response to bookmarking a multimedia content, a bookmark corresponding to the multimedia content is saved on a server. The bookmark can be accessed by the user and one or more users who have been provided an access to the server by the user. Additionally, one or more advertisements are associated with a multimedia content. Whenever, a multimedia content is accessed, a content owner of the multimedia content is notified. The notification includes the location of a user viewing the multimedia content and the number of times the multimedia content has been viewed. Therefore, the content owner receives an accurate advertisement monetization.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for managing at least one multimedia content, the method comprising:
bookmarking the at least one multimedia content;
storing at least one bookmark in a server in response to bookmarking the at least one multimedia content, wherein a bookmark corresponds to a multimedia content; and
accessing the at least one multimedia content using the at least one bookmark stored in the server, wherein accessing at least one multimedia content using the at least one bookmark monetizes at least one advertisement associated with the at least one multimedia content.

2. The method of claim 1 further comprising providing access to the server to at least one user.

3. The method of claim 2, wherein the at least one user is notified in response to storing the at least one bookmark.

4. The method of claim 2, wherein accessing a multimedia content using a corresponding bookmark displays the multimedia content on a device used by a user.

5. The method of claim 2, wherein accessing a multimedia content using a corresponding bookmark downloads the multimedia content on a device used by a user.

6. The method of claim 5, wherein the device is one of a Set Top Box (STB), a television, a cell phone, a Personal Digital Assistant (PDA), a computer, a laptop, a palmtop, and an e-book.

7. The method of claim 2, wherein the at least one bookmark is aggregated in the server.

8. The method of claim 7, wherein the at least one bookmark is aggregated to arrange the at least one bookmark in a list stored in the server.

9. The method of claim 8, wherein a bookmark is placed in the list in accordance with an access pattern corresponding to the bookmark, the access pattern corresponds to a pattern of accessing the bookmark.

10. The method of claim 1 further comprising associating the at least one advertisement with a multimedia content accessed using a corresponding bookmark stored in the server.

11. The method of claim 10, wherein a content owner of the multimedia content is sent a notification in response to accessing the multimedia content using the corresponding bookmark enabling monetizing of the at least one advertisement.

12. The method of claim 11, wherein the notification comprises information corresponding to a method used to view the at least one advertisement associated with the multimedia content.

13. The method of claim 1 further comprising downloading a script, wherein the script enables storing of a bookmark in the server in response to bookmarking a multimedia content, the bookmark corresponds to the multimedia content.

14. A method for accessing at least one multimedia content from a server, the method comprising:
obtaining a notification in response to at least one bookmark being stored in the server, wherein a bookmark corresponds to a multimedia content; and
retrieving the at least one multimedia content using the at least one bookmark, wherein retrieving comprises:
associating at least one advertisement with each multimedia content.

15. The method of claim 14 further comprising receiving an access to the server.

16. A system for managing at least one multimedia content, the system comprising:
a bookmarking module to store at least one bookmark in a server in response to bookmarking the at least one multimedia content, wherein a bookmark corresponds to a multimedia content; and
a communicating module to communicate a notification to at least one user in response to storing the at least one bookmark in the server.

17. The system of claim 16 further comprising an associating module to associate at least one advertisement with a multimedia content.

18. The system of claim 16, wherein the communicating module sends a notification to a content owner of a multimedia content, if the multimedia content is accessed using a corresponding bookmark.

19. The system of claim 16 further comprising an aggregating module to aggregate the at least one bookmark in the server.

20. The system of claim 19, wherein the aggregating module aggregates the at least one bookmark to arrange the at least one bookmark in a list stored in the server.

21. The system of claim 16, wherein the communicating module provides at least one user an access to the server.
